(19) United States
(12) Patent Application Publication
(10) Pub. No.: US 2009/0035501 A1
(43) Pub. Date: Feb. 5, 2009

(54) COMPOSITE PRODUCT

(76) Inventor: Neil Edwin Wallace, New South Wales (AU)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/159,539

(22) PCT Filed: Dec. 28, 2002
(86) PCT No.: PCT/AU2006/001961

§ 371 Date: Oct. 7, 2008

(30) Foreign Application Priority Data
Dec. 29, 2005 (AU) 2005907332
Oct. 9, 2006 (AU) 2006905593
Oct. 9, 2006 (AU) 2006905594

(51) Int. Cl. B32B 1/08; B32B 15/08; C08F 110/02; C08F 110/06; C08F 114/06

(52) U.S. Cl. 428/35.7; 428/457; 526/352; 526/351; 526/344.3

(57) ABSTRACT

A composite product (1, 2, 3, 4, 300) comprises a body (100, 200, 301) and a polymeric component (41, 50, 51, 55) cast onto a surface of the body. In one form, the product is for water infrastructure and the body is in the form of a hollow section and a water impermeable interface is formed between the body surface and the component.

### FIELD OF THE INVENTION

The present invention relates generally to composite products and especially, but not exclusively, to composite products for water infrastructure (such as pipes, channels, water detention or retention systems, and tanks). The products typically include a closed or open hollow section designed to contain or convey water. Such products are typically used across a broad range of water types including mains water, rain water and waste water (including storm water, grey water and sewerage). However, it is to be appreciated that the invention has broader application and is not limited in that use.

In a particular application the water infrastructure products include a hollow section made from metal, preferably from a steel strip that has a corrosion resistant metal coating, and the invention is described in that context. However, it is to be appreciated that the invention has broader application and is not limited to that use.

### BACKGROUND OF THE INVENTION

There are a wide range of potential applications for water infrastructure products made from steel strip.

These applications include pipes for conveying town water, sewerage or storm water, irrigation systems, and culverts. Other applications for steel strip include water tanks and water retention or detention systems.

In one form, the steel strip may be formed into pipes having a closed hollow section and which may incorporate external profiling that extend along the length of the pipe to increase its strength. In one form, this profiling extends helically about the section with the section being manufactured using a process of spiral winding of the steel strip.

It has been found beneficial in at least some instances to form products such as the above water infrastructure products, as a composite construction where a polymeric component is connected to the metal section. This component may serve a variety of purposes. For example, the component may provide at least part of a coupling to allow the section to be connected to another section forming a watertight seal at the coupling. Alternatively, the polymeric component may be used as part of a base or lid structure for a water tank or detention/retention system.

### SUMMARY OF THE INVENTION

In a first aspect the invention provides a composite product comprising a body, and a polymeric component cast onto a surface of the body.

In accordance with this aspect of the invention, the polymeric component is formed as a casting onto the body surface. Such an arrangement has substantial practical benefit in that it can simplify the manufacturing of the product. Further, because the polymeric material is introduced as a fluid onto the section surface, the surface of the component can match the surface of the body even when that surface is profiled to incorporate stiffening ribs or the like.

In the context of the specification, the term “cast” or variations such as “casting” and the like as used in relation to the polymeric components includes all moulding techniques and/or resulting articles formed by such techniques, where the polymeric material is introduced into a mould so as to form the component into a particular shape.

In one form, the component is bonded to the body surface as a result of being cast onto that surface. In a particular form, the bonding between the component and the section surface provides a fluid seal between the body and the component.

In one form, the product is for water infrastructure and the body is in the form of a hollow section.

In a further aspect, the invention provides a water infrastructure product comprising a body in the form of a hollow section, a polymeric component cast onto a surface of the body, and a water impermeable interface formed between the section surface and the component.

In one form, the body is formed from sheet metal and in a particular form is made from sheet steel that incorporates a corrosion resistant metal coating.

In a particular form where the component is bonded to the body surface, the product may further comprise an intermediate layer between the body and the polymeric component which aids in that bonding process. In one form, that intermediate layer is introduced during casting of the component onto the product. In another form, the layer is introduced prior to casting.

In a particular form, the intermediate layer is applied to the metal where the body is formed from metal prior to casting of the component and forms a polymeric coating on the metal. In a particular form, this polymeric coating is in the form of a polymeric film. The polymeric film not only aids in bonding of the component to the section but may be used for other purposes. For example the polymeric film may provide a moisture barrier and/or enhance the chemical resistance of the metal. Such polymeric films may include low density or high density polyethylene, PVC and polypropylene. One suitable polymeric film is sold under the trade mark TRENCHCOAT™ LG. Another PVC coated steel sheet product used in water infrastructure products is sold by the applicant under the trade mark AQUAPLATE™.

In one form, the body surface on which the polymeric component is cast is profiled. This profiling may take various forms and may be comprised of stiffening formations such as corrugations, ribs or the like which are provided to increase the structural properties of the section. Alternatively or in addition, the surface may be profiled to improve the fluid seal between the section surface and the component by providing a torturous path at the interface to restrict the penetration of water through that interface. Furthermore, the profiling of the body surface may additionally, or alternatively improve the connection between the component and the body surface by creating a mechanical interference that effectively keys those two parts together.

The provision of a physical barrier to fluid penetration through the interface and/or the creation of a mechanical interference may be improved by injecting the polymeric material into the casting mould under pressure and/or by controlling shrinkage of the component onto the surface of the body as it cools after casting.

In one form, the body is a pipe with a closed section. In a particular form, the pipe includes at least one external rib which extends between opposite ends of the pipe. Once such pipe that is formed from steel incorporating the TRENCHCOAT™ LG film is manufactured and sold by the applicant under the trade mark HYDRORIB™.

In one form, the component is cast onto the pipe so as to form a coupling for that pipe. In one form, the coupling is formed at the end of the pipe. Alternatively it may be formed at an intermediate section of the pipe to provide a branch coupling for that pipe.

It is to be appreciated that because the polymeric component is cast onto the body surface there is a great deal of flexibility into the shaping of that component. Further, whilst in one form the component may be cast into its final shape, in an alternative arrangement, the component may be cast as a preform which may then be subsequently processed (such as by a milling operation) to shape the component into its final shape.

### BRIEF DESCRIPTION OF THE DRAWINGS

It is convenient to hereinafter describe embodiments of the present invention with reference to the accompanying drawings. It is to be appreciated that the particularity of the drawings and the related description is to be understood as not limiting the preceding broad description of the invention.

In the drawings:

FIGS. 1A, 1B and 1C are schematic views of various pipe couplings incorporating polymeric components used in water infrastructure;

FIG. 2 is a schematic view of a branch junction for a pipe;

FIG. 3 is a schematic sectional view of a water tank incorporating a polymeric base coupling;

FIG. 4 is a schematic side view of a moulding apparatus connected to an end of a host section;

FIG. 5 is an end view of the moulding apparatus of FIG. 4;

FIG. 6 is a schematic sectional view of the moulding apparatus connected to the host section, where that section has an external ribbed configuration;

FIG. 7 is a variation of the view of FIG. 6 where the host section is corrugated;

FIG. 8 is a further variation of a pipe coupling of FIG. 1C in an exploded view;

FIG. 9 is an assembled view of the pipe coupling of FIG. 8; and

FIG. 10 is a sectional view of the pipe coupling of FIG. 8.

### DETAILED DESCRIPTION OF THE DRAWINGS

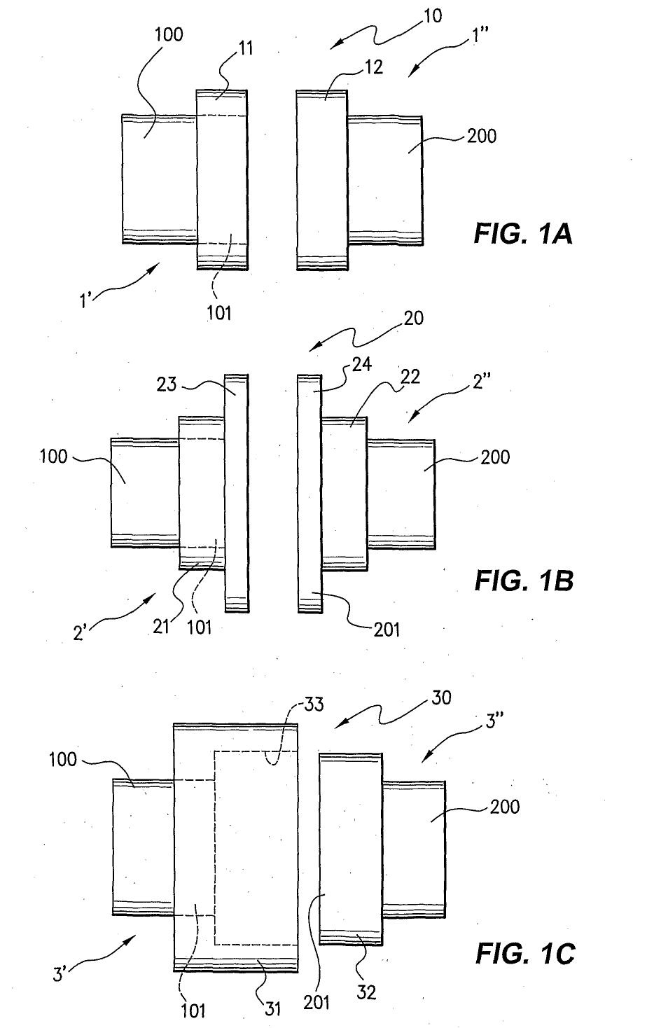

FIGS. 1A to 1C illustrate various couplings 10, 20 and 30 for connecting first and second pipes 100 and 200. The couplings incorporate polymeric components which are moulded to ends of the pipe to form composite products 1, 2, 3 as will be described in more detail below.

In the illustrated form, the pipes 100 and 200 are formed from sheet steel that incorporates a corrosion resistant coating. Further, the steel may be profiled to include stiffening formations so as to increase the strength of the pipe. These stiffening formations may be in the form of ribs, corrugations or the like. Furthermore, the pipes 100 and 200 may be coated with a polymeric material. This polymeric material may be in the form of a film that provides a moisture barrier and/or enhances the chemical resistance of the sheet metal. Such polymeric films may include low or high density polyethylene, PVC and polypropylene. Further, the polymeric film may facilitate bonding of the polymeric components to the respective pipes.

An example of a pipe that is formed from sheet steel strip that includes external ribs that extend helically along the pipe is sold by the applicant under the trade mark HYDRORIB. This pipe incorporates an LD polyethylene film coating sold under the trade mark TRENCHCOAT™ LG and is formed by a process of spiral winding the steel strip.

The pipes 100, 200 are arranged to be connected through the couplings 10, 20 and 30 in end to end relationship and in a watertight manner so as to be able to convey water over indefinite lengths. The infrastructure provided by the pipes 100, 200 may be pressure rated so as to supply town water or water for irrigation or may be non-pressurised and used in applications such as culverts or storm water. The efficacy of the seal formed by the couplings 10, 20 or 30 dictate largely the pressure rating of the pipes.

In the embodiment illustrated in FIG. 1A, the coupling 10 incorporates a first polymeric coupling 11 formed at the end of the first pipe 100 to form a first composite product 1^{I} and a second polymeric coupling 12 formed at the end of the other pipe 200 to form a second composite product 1^{II}. These couplings are arranged to abut one another to form a butt connection between the pipes 100 and 200. A clamping element (not shown) may be disposed over the couplings so as to retain them in position.

In the embodiment illustrated in FIG. 1B, a first coupling 21 is formed on the pipe end 101 whereas a second coupling 22 is formed on the end 201 of the second pipe 200 to form composite products 2^{I} and 2^{II}. Each of the couplings include a flange (23, 24 respectively) at its outer end and these flanges are arranged to butt together in connection of the coupling 20. Whilst not shown, typically fasteners, such as a nut and bolt, extends through the flanges 23 and 24 to maintain the pipes together.

In the embodiment in FIG. 1C, the coupling 30 is of a bell and spigot type with the bell 31 being formed on the end of the pipe 100, and the spigot 32 formed on the end of the other pipe 200 thereby forming composite products 3^{I} and 3^{II}. Location of the spigot 32 into the cavity 33 of the bell 31 connects the pipes 100 and 200 together and effects the seal therebetween.

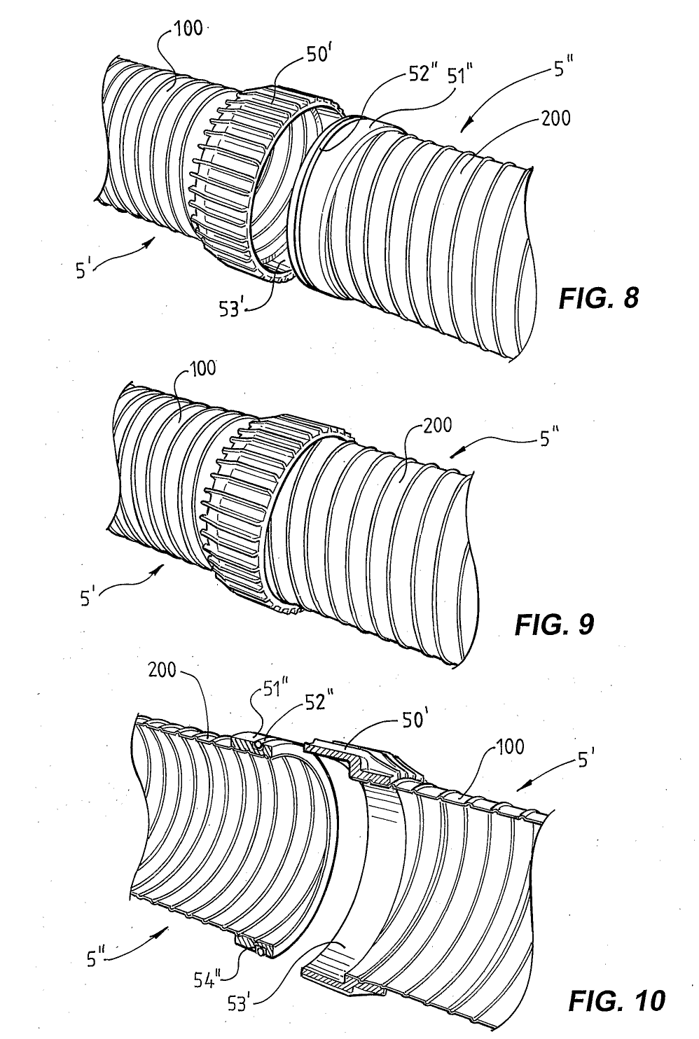

The embodiments of FIGS. 1A to 1C illustrate general coupling types which are ideally formed from polymeric components. As will be appreciated by those skilled in the art, it may be necessary to incorporate seals such as “O” ring seals or pressure seals to provide a watertight joint. An example of such an arrangement is shown in FIGS. 8 to 10.

In the embodiment of FIGS. 8 to 10, a first coupling element (bell) 50^{I} is disposed on the end of one pipe 100 and forms the female component whereas the other coupling element (spigot) 51^{II} is disposed on the end of the other pipe 200 and forms the male connection to form composite products 5^{I} and 5^{II}. A pressure seal 52^{II} is disposed on the male component 51^{II} and is designed to engage with an internal surface 53^{I} of the female component 50^{I}. The pressure seal is set partly into a recess 54^{II} formed in an outer surface of the male component 51^{II}.

A watertight joint is formed by locating the male component 52^{II} into the bore 53^{I} of the female component 50^{I}. The pressure seal 51^{II} forms the watertight seal and is designed to move into tighter engagement with the coupling elements 50^{I} and 51^{II} under increased pressure in the pipes thereby not only increasing the seal but also inhibiting inadvertent release of the pipes. This obviates the need for any separate clamping element to keep the pipe lengths 100, 200 axially aligned.

In addition to the seal formed between the coupling elements, the effectiveness of the coupling to be watertight will depend to some extent on the interface between the respective polymeric component and the host pipe. The provision of this watertight interface between these parts will be described in more detail below.

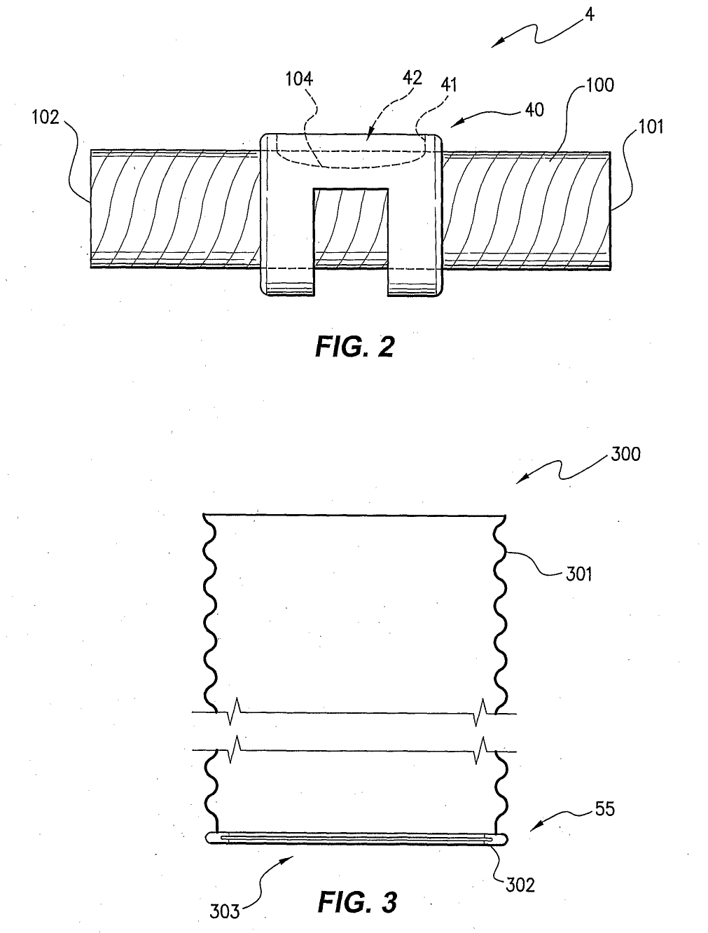

FIG. 2 illustrates a further variation of coupling 40 for a host pipe 100. In this embodiment, the coupling 40 is used to provide a branch line to the pipe 100 and as such, is formed intermediate the ends (101, 102) of the pipe 105. In the illustrated form, the coupling 40 forms a polymeric collar 41 which projects from the pipe surface. This collar 41 and pipe 100 form composite product 4 with the collar 41 defining a central cavity 42 in which an aperture 104 in the underlying pipe wall is located. With this arrangement, a second pipe having a suitable coupling on its end can be connected into the pipe 100 at the coupling 40.

Whilst in one form the coupling 40 may be formed offsite, in an alternate arrangement the coupling may need to be made onsite on an already laid pipe. In that arrangement, the polymeric component 41 is moulded onto the pipe wall, and the aperture 104 is tapped into the pipe onsite.

FIG. 3 illustrates a further type of water infrastructure product, namely a water tank 300. In the embodiment of FIG. 3, the water tank 300 is again a composite product and is formed with a cylindrical wall 301 which is made from a profiled sheet metal strip. Again this sheet metal strip may be sheet steel which incorporates a corrosion resistant metal coating and typically incorporate a polymeric coating. An example of a suitable PVC coated sheet steel strip is sold by the applicant under the trade mark AQUAPLATE™. The sheet metal strip may be profiled with corrugations or ribs and the tank wall may be made from a spiral winding of the sheet strip or in a more conventional configuration, the tank wall is built up by a series of cylindrical panel elements which are disposed one on top of the other.

In the embodiment of FIG. 3, the tank incorporates a polymeric component 55 which is cast onto the bottom of the tank wall 302. This polymeric component forms part of a base assembly 303 for the tank 300.

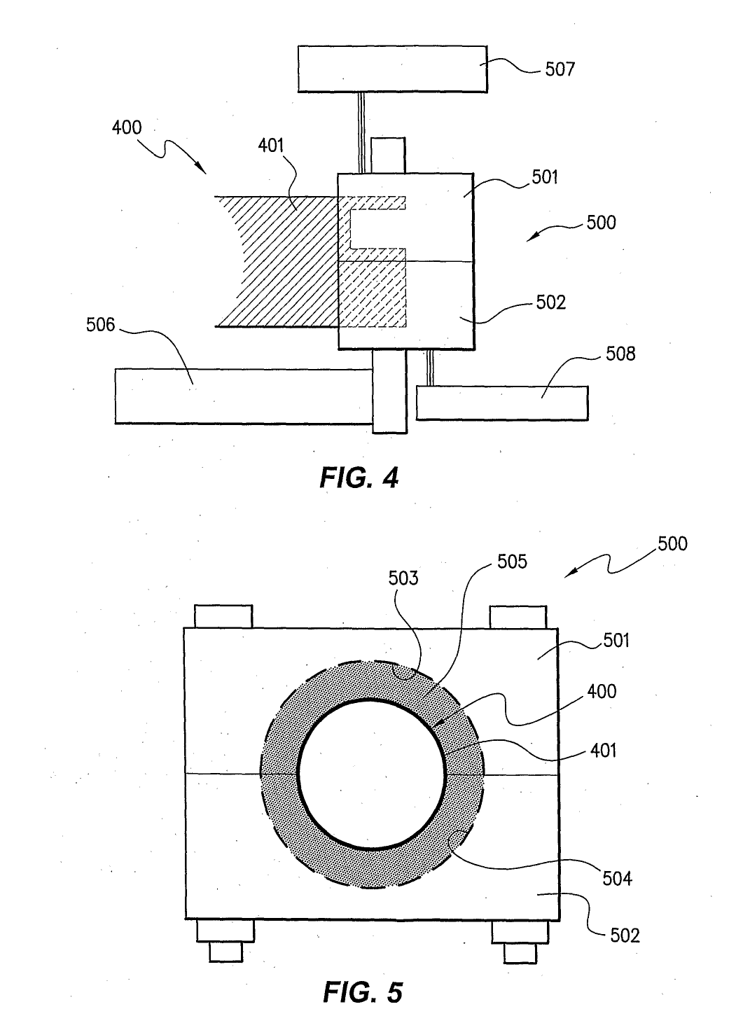

In each of the embodiments illustrated above, the polymeric components are cast directly onto the product section 100, 200 or 300. FIGS. 4 to 7 illustrate this process of casting in more detail.

Turning firstly to FIGS. 4 and 5, to cast the components onto a product section 400, a moulding apparatus 500 is provided which incorporates mould shells 501 and 502 which clamp around the product section 400. The mould shells 501, 502 each have an interior mould wall 503 and 504 which when clamped to the product section 400 form, in conjunction with an outer surface 401 of the host section, a closed cavity 505 in which the polymeric material can be introduced.

The apparatus 500 further comprises a feed assembly 506 for introducing the polymeric material into the mould cavity 505. This assembly is typically in the form of an a extruder/injector system which introduces the polymer material in a liquid form under relatively low pressure (typically in the order of 210 kpa-480 kpa) so as not to deform the product section 400. Furthermore, single or multiple injection paths may be used to combine the properties of one or more polymers or other extruded materials to create both a homogenous or heterogenous structures that have an influence upon the physical properties and economics of the final moulded component.

The injected polymeric material may be derived from resins associated with polyolefin, ethylene vinyl acetates, poly vinyl chloride, polypropylenes, polycarbonates, nylon and associated blends. These polymeric materials may in addition or alternatively comprise rubber related compounds and may or may not be reinforced by the addition of ceramic or glass beads, directional fibres and/or solid inserts manufactured from polymer for metallic components. The composition of the polymeric material may vary as will be appreciated by persons skill in the art and as such is outside the scope of the invention.

To control the operating parameters of the moulding process, the host section 400 and/or the mould shells 501, 502 may be heated to aid the particular polymer flow characteristics. Typically this will be done via a mould heat apparatus 507. Further, these components may be selectively cooled (by apparatus 508) to control the material flow and shrinkage of the moulded component. In one form, the mould and pipe and cooled to room temperature over a period of less than 15 minutes. Further a fluid seal may be formed between the mould as the section surface by rapid cooling of the polymeric material in the region of that join. Alternating a fluid seal may be provided by the use of a gasket at the join.

In addition, gases and or other chemical blowing agents may or may not be added to the polymer material either at the time of formulation or at the point of injection of the polymer to the mould to increase the pressure within the mould to enable the polymeric material to fully take up the shape of the cavity and to control shrinkage of the moulded part and/or the specific filling characteristic of the polymers and the mould cavity. In one form, this process carries the polymeric component to have a more deuse periphery as compared to an inner core of that component.

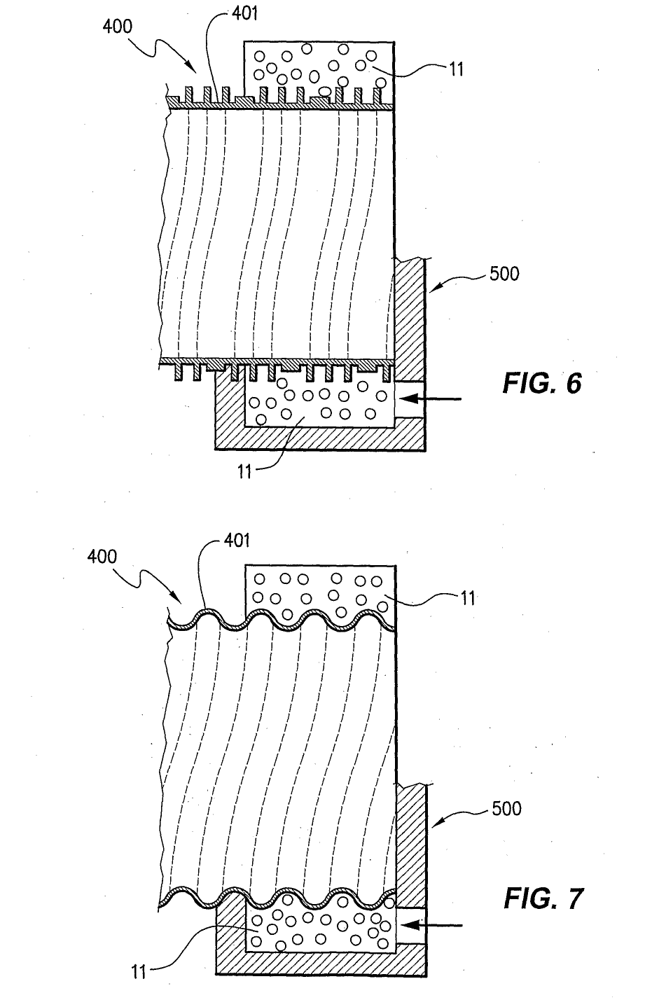

FIGS. 6 and 7 schematically illustrate the moulds 500 shown in the embodiment of FIG. 5, when connected to an externally ribbed smooth bore steel pipe (FIG. 6) and a corrugated host pipe (FIG. 7).

In view of the direct casting of the polymeric component 11 onto the host surface 401 it is possible for the component to precisely take up the shape of that surface so that it is intimately in contact with that surface substantially along the entire interface between those parts. This substantially improves the effectiveness of the interface or joint between these parts to prevent water penetration.

In one form, by choosing appropriate materials, it is possible to achieve a strong bond between the polymeric component and the host section. In one form the polymeric material may bond directly onto a metal surface. Alternatively, the pipe may be pre-coated with a polymeric coating such as that described above so as to enable that coating to bond with the polymeric material of the component. In that arrangement, the coating may be heated to become tacky to assist in formation of the bond between the section and the component. Typically the coating is heated in the range of 90° to 180° and more preferably about 130°.

In addition, if the host section 400 has a profiled outer surface, as illustrated in FIGS. 6 and 7, then the casting of the polymeric components onto that surface provides a mechanical interference which both improves the strength of the connection and also creates a torturous path which can aid in inhibiting water penetration through the interface between the parts. This mechanical interference may be improved by the polymeric component shrinking during cooling after it is cast.

By casting the components onto the host section, it can obviate or at least substantially reduce the need to further shape the components after they have been cast. However, it is to be appreciated that if some complex shapes are required, then some post forming may be necessary. However, in many instances no post forming will be required. This not only provides the advantage of simplifying the process for forming the components and also the equipment that is necessary, but also provides an arrangement where the components can be cast onsite. This is particularly advantageous in water infrastructure where connection need to be made on site for example to install new sections of channels or pipes.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Variations and modifications may be made to the parts previously described without departing from the spirit or ambit of the invention.

1. A composite product comprising a body, and a polymeric component cast onto a surface of the body, the component forming a coupling for the product.

2. A product according to claim 1, wherein the component is bonded to the body surface as a result of being cast onto that surface.

3. A product according to claim 1, wherein the body surface is profiled to provide a torturous path at the join between the body and the component.

4. A product according to claim 1, wherein the body is profiled so as to create a mechanical interference between the component and the body so as to improve the connection therebetween.

5. A product according to claim 1, wherein the body is profiled to include stiffening formations which increase the structural properties of the body.

6. A product according to claim 1, wherein the body is formed from sheet metal.

7. A product according to claim 6, wherein the body is formed from sheet steel that incorporates a corrosion resistant metal coating.

8. A product according to claim 6, wherein the product further comprises an intermediate layer between the metal sheet and the polymeric component.

9. A product according to claim 8, wherein the intermediate layer is in the form of a polymeric coating applied to the sheet metal.

10. A product according to claim 1, wherein the product is for water infrastructure, the body being shaped to convey or contain water and a water impermeable interface is formed between the body and the component.

11. A water infrastructure product comprising a body in the form of a hollow section, a polymeric component cast onto a surface of the body and forming a coupling for the product, and a water impermeable interface formed between the body surface and the component.

12. A product according to claim 11, wherein the component is bonded to the body surface as a result of being cast onto that surface, wherein the bonding between the component and the body surface provide at least part of the water impermeable interface between the body surface and the component.

13. A product according to claim 11, wherein the body surface is profiled and wherein the profiling of the surface improves the water impermeable interface between the body surface and the component by providing a torturous path at the interface to restrict penetration through that interface.

14. A product according to claim 11, wherein the body surface is profiled so as to create a mechanical interference between the component and the body so as to improve the connection therebetween.

15. A product according to claim 13, wherein the product is profiled to include stiffening formations which increase the structural properties of the section.

16. A product according to claim 11, wherein the body is formed from sheet metal.

17. A product according to claim 16, wherein the body is formed from sheet steel that incorporates a corrosion resistant metal coating.

18. A product according to claim 16, wherein the product further comprises an intermediate layer between the metal sheet and the polymeric component.

19. A product according to claim 18, wherein the intermediate layer is in the form of a polymeric coating applied to the sheet metal.

20. A product according to claim 11, wherein the body is in the form of a pipe having a closed section.

21. A product according to claim 20, wherein the pipe includes at lest one external stiffening formation which extend between opposite ends of the pipe.

22. A product according to claim 21, wherein the component is formed at an end of the pipe to enable coupling of the pipe with an end of another pipe.

23. A product according to claim 21, wherein the component is formed intermediate the ends of the pipe.

24. A product according to claim 1, wherein the polymeric component is a pre-form and is arranged to be shaped after casting into its final shape.

25. A product according to claim 1, wherein the body is in the form of a pipe, and the coupling is arranged for connecting to a complementary coupling on another pipe to connect the pipe to said another pipe.

26. A product according to claim 25, wherein the coupling is formed at one end of the pipe and the complementary coupling is formed at the other end of the pipe.

27. A product according to claim 25, wherein a fluid seal is formed between the body and the component.
